(19) United States
(12) Patent Application Publication
(10) Pub. No.: US 2006/0239758 A1
(43) Pub. Date: Oct. 26, 2006

(54) Sauce spreading device

(76) Inventor: Brett Di Paolo, Brampton (CA)

Correspondence Address: GEORGE A. ROLSTON, 45 SHEPPARD AVE EAST, SUITE 900, TORONTO, ON, M2N5W9, CA

(21) Appl. No.: 11/411,114

(22) Filed: Apr. 26, 2006

Related U.S. Application Data
(60) Provisional application No. 60/674,688, filed on Apr. 26, 2005.

(51) Int. Cl. B43K 5/04

(52) U.S. Cl. 401/153; 401/152

(57) ABSTRACT

A sauce spreading device for dispensing and spreading a sauce on food a handle member, a sauce dispensing mechanism, a receptacle member and a base, the sauce dispensing mechanism substantially positioned within the handle member and being movably actuated between an engaged position and returnably actuated to a disengaged position, the receptacle member having a proximal end and a distal end, the handle member being coupled to the proximal end of the receptacle member, the receptacle member having a body member for accommodating a cartridge containing the sauce, the header member being coupled to the distal end of the receptacle member and having an input aperture, an output aperture and a passageway in fluid communication with the cartridge and extending from the input aperture to the output aperture, wherein the movable actuation of the sauce dispensing member causing the cartridge to be collapsed so that the sauce is dispensed from the cartridge through the base, and wherein the returnable actuation of the sauce dispensing member causing the collapsed cartridge to be elongated so that the dispensing of the sauce from the cartridge through the base is substantially stopped.

### PRIOR APPLICATION

This application claims the benefit of U.S. Provisional Application Ser. No. 60/674,688, filed Apr. 26, 2005, entitled SAUCE SPREADER DEVICE.

### FIELD OF THE INVENTION

The invention relates to a sauce spreading device for dispensing and spreading a sauce onto food.

### BACKGROUND OF THE INVENTION

Outdoor barbequing is an increasingly popular cooking technique which produces foods, such as steak, chicken and vegetables, having unique flavors and textures which cannot be easily duplicated in a traditional kitchen. Commonly, barbeque users apply sauces and marinades from various ethnic and cultural cuisines to further enhance the taste characteristics and textures of the food cooking on the barbeque grill. Known techniques for marinating foods using a squeeze bottle or soaking the food in a container filled with the sauce and/or marinade can be time consuming and messy undertakings. Moreover, these techniques often result in an uneven distribution of the sauce and marinade on the surface of the food. This uneven distribution of sauce and marinade can result in excess sauce and marinade dripping into the barbeque and producing smoke and poor tasting cooked foods. Moreover, the burnt remnants of the excess sauce and marinade on the grill may become dislodged during cooking and be ingested by the barbeque user or their guests.

The use of a plurality of cooking accessories, such as cooking utensils, squeeze bottles and/or marinating containers, simultaneously adjacent to the heated surface of the barbeque grill can be unsafe for the barbeque user. Particularly, the use of the cooking accessories may result in the barbeque user accidentally burning their hand, wrist or arm on the barbeque when reaching for additional accessories. Dropping one or more of these individual accessories may also result in considerable damage to the cooking surface of the barbeque grills and the heating element within the barbeque. Moreover, given that there is limited space on barbeques to store these cooking accessories, it often occurs that the barbeque user must step away from the barbeque to locate the appropriate utensil(s), for example, for each of these purposes. During which time the foods may become adhered to the grill and/or burn as a result of the intense flame of the barbeque.

Accordingly, there is a need for a sauce spreading device for easily dispensing and spreading a measured amount of sauce on food grilling on a barbeque. There is a further need for a sauce spreading device having a cartridge that may be removed and replenished or replaced with another cartridge containing a different sauce. There is also a need for a sauce spreading device having an elongate handle member that maintains the barbeque user's hands and wrists at safe distance from the grill when marinating the food.

### SUMMARY OF THE INVENTION

The present invention is directed to a sauce spreading device for dispensing and spreading a sauce on food consisting of a hollow handle member, a sauce dispensing mechanism substantially positioned within the handle member, the sauce dispensing mechanism being movably actuated between an engaged position and returnably actuated to a disengaged position, a receptacle member having a proximal end and a distal end, the handle member being coupled to the proximal end of the receptacle member, the receptacle member having a body member for accommodating a cartridge containing the sauce, a base coupled to the distal end of the receptacle member, wherein the base having an input aperture, an output aperture and a passageway in fluid communication with the cartridge and extending from the input aperture to the output aperture, wherein the movable actuation of the sauce dispensing member causing the cartridge to be collapsed so that the sauce is dispensed from the cartridge through the base, and wherein the returnable actuation of the sauce dispensing member causing the collapsed cartridge to be elongated so that the dispensing of the sauce from the cartridge through the base is substantially stopped.

Preferably, the sauce dispensing mechanism consists of a piston and a drive screw rotatably supported on the handle member, wherein the rotation of the drive screw relative to the handle member provides axial movement of the piston within the handle member. The piston further consisting of a rod having threads at least partially along its length and an end cap for engaging with an end of the cartridge.

Preferably, the base consisting of a base member and an outer cover member releasably coupled to the base member, the base member formed with the output aperture therethrough, and the outer cover member formed with an outer aperture in fluid communication with the output aperture. The pivotal member being disposed between the base member and the outer cover member and adapted for pivotally moving between a closed position and an open position to control the amount of sauce dispensed through the outer aperture. The base member being provided with a recessed portion which is adapted to receive and enable the pivotal movement of the pivotal member between the closed position and the open position. The pivotal member pivots about a first cooperating pivot point on the base member and a second cooperating pivot point on the outer cover member. The pivotal member has a lever engageable by fingers for pivotally moving the pivotal member between the closed position and the open position.

Preferably, the base includes a plurality of protrusions extending generally perpendicularly from a surface of the outer cover member for spreading the sauce dispensed through the outer aperture. The outer cover member is independently replaceable. The plurality of protrusions are manufactured from a flexible plastic material.

Preferably, the cartridge has a pleated bellows formed with an orifice at one end and adapted to contain the sauce to be dispensed through the orifice upon the collapse of the pleated bellows. The cartridge is formed of a resilient material for normally biasing the bellows to an elongated condition. The body member is provided with a first clamp and a second clamp for releasably securing the cartridge to the body member.

Preferably, the handle member is provided with a heat-resistant sleeve. The first end of the handle member is provided with a hook means.

The present invention is also directed to a sauce spreading device for dispensing and spreading a sauce on food consisting of a hollow handle member, a receptacle member having a proximal end and a distal end, the handle member being coupled to the proximal end of the receptacle member, the receptacle member accommodating a cartridge containing the sauce and having a pleated bellows and an orifice at one end, a sauce dispensing mechanism substantially positioned within the handle member to engage and collapse the pleated bellows to dispense the sauce through the orifice.

Preferably, a base is coupled to the receptacle member, wherein the base has an input aperture, an output aperture and a passageway in fluid communication with the orifice and extending from the input aperture to the output aperture. A plurality of protrusions extending generally perpendicularly from an outer cover member of the base adapted for spreading the dispensed sauce. The sauce dispensing mechanism further consisting of a piston and a drive screw rotatably supported on the handle member, wherein the rotation of the drive screw relative to the handle member provides axial movement of the piston within the handle member to collapse the pleated bellows.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a side elevation view of a sauce spreading device made in accordance with a preferred embodiment of the invention;

FIG. 2 is an exploded perspective view of the sauce spreading device of FIG. 1;

FIG. 3 is a top plan view of the sauce spreading device of FIG. 1;

FIG. 4 is bottom perspective view of the sauce spreading device of FIG. 1;

FIG. 5 is a side elevation view of the sauce spreading device of FIG. 1;

FIG. 6 is a cross-sectional view of the sauce dispensing mechanism substantially positioned within the handle member and being movably actuated in the direction B;

FIG. 7 is a side elevation view of the sauce spreading device of FIG. 1;

FIG. 8 is a cross-sectional view of the sauce dispensing mechanism substantially positioned within the handle member and being returnably actuated in the direction C;

FIG. 9 is a side elevation view of the base of the sauce spreading device of FIG. 1;

FIG. 10 is a plan view of the recessed portion and output aperture of the lower section of the sauce spreading device of FIG. 1;

FIG. 11 is a plan view of the lower section of the sauce spreading device of FIG. 1 showing the pivotal member in a closed position;

FIG. 12 is plan view of the lower section of the sauce spreading device of FIG. 1 showing the pivotal member in an open position;

FIG. 13 is a plan view of the lower section of the sauce spreading device of FIG. 1 showing the pivotal member in a partially open position;

### DETAILED DESCRIPTION OF THE INVENTION

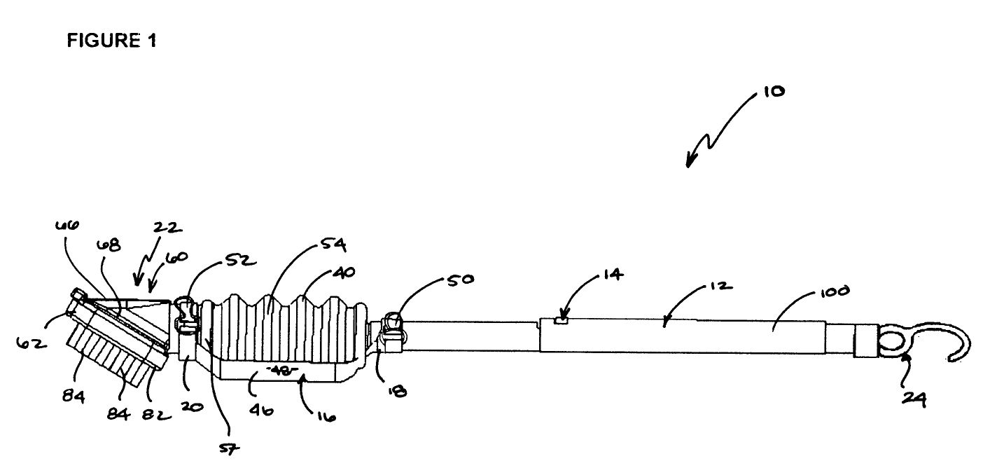

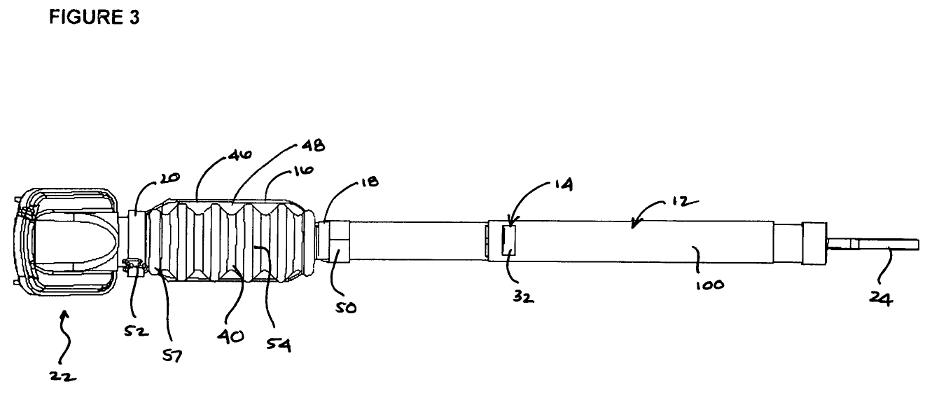

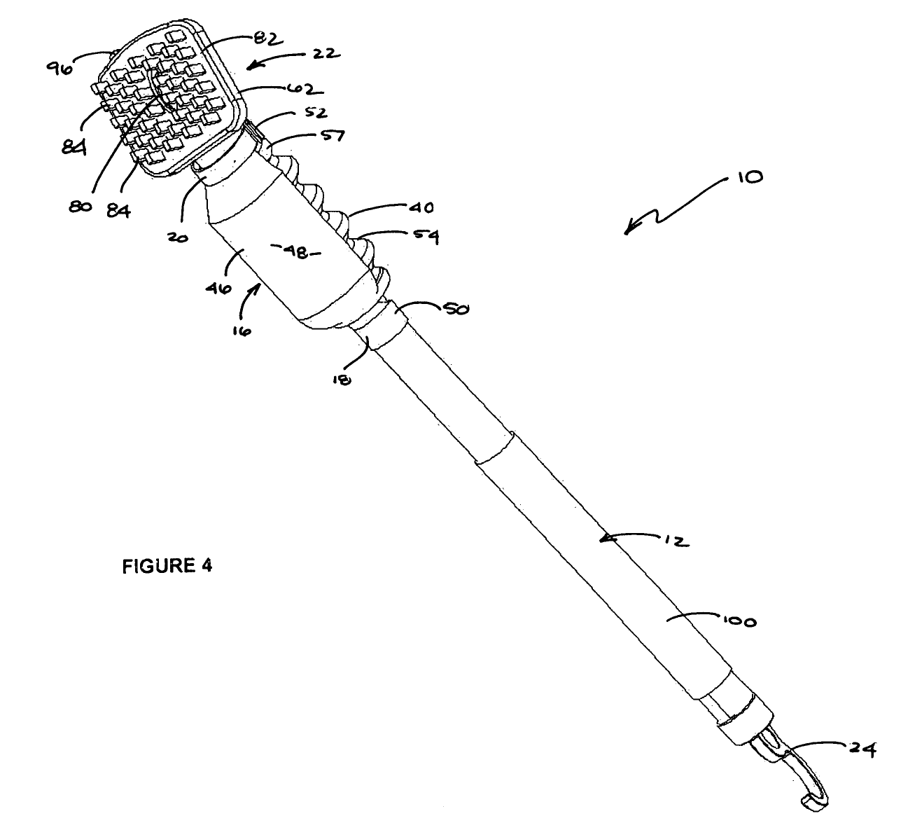

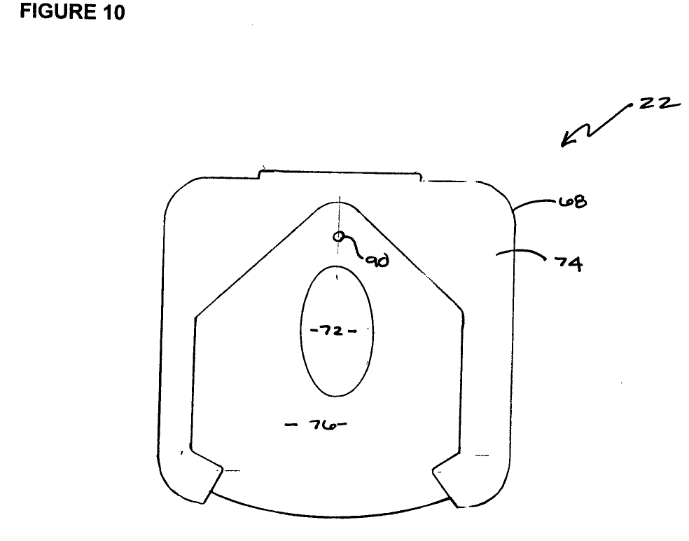

Reference is made to FIGS. 1-13 which illustrate a sauce spreading device 10 for dispensing and spreading a sauce on food made in accordance with a preferred embodiment of the invention. The sauce spreading device 10 has a hollow handle member 12, a sauce dispensing mechanism 14 substantially positioned within the handle member 12, a receptacle member 16 having a proximal end 18 releasably coupled to the handle member 12 and a distal end 20 releasably coupled to a base 22. The handle member 12 may have an optional hook means 24 to allow the sauce spreading device 10 to be attached to an oven or barbeque, for example. The sauce dispensed from the sauce spreading device 10 of the present invention may be any suitable marinade, condiment or liquid seasoning that a cook, such as a barbeque user, may desire to apply to a food to enhance the taste characteristics and textures of the food cooking in an oven or a barbeque.

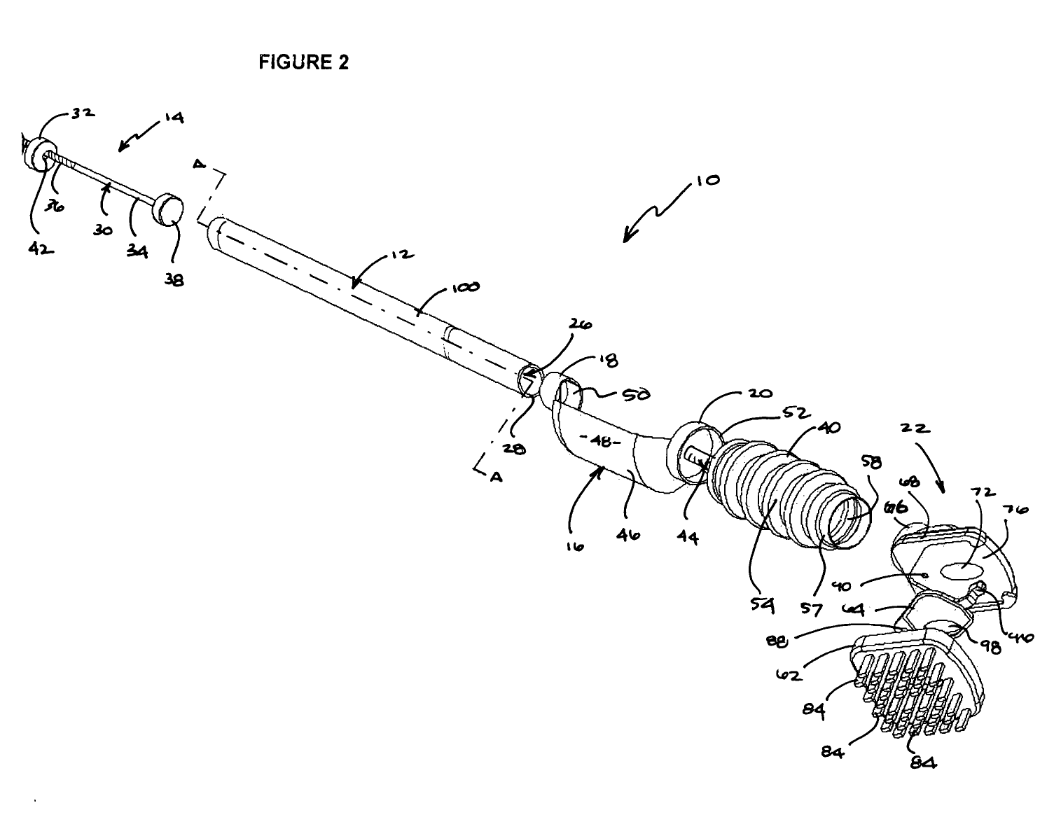

Referring to FIG. 2, the handle member 12 is of a generally cylindrical configuration having a bore 26 and a mouth opening 28 centered along a longitudinal axis A-A. It should be understood that the handle member 12 may have any cross-section, such as, for example, oval, oblong, polygonal, circular or any other suitable shape permitting the comfortable and stable gripping of the sauce spreading device 10 by the barbeque user. The bore 26 is dimensioned to receive the sauce dispensing mechanism 14 which is disposed therein for movable and returnable actuation along the longitudinal axis A-A towards and from the mouth opening 28.

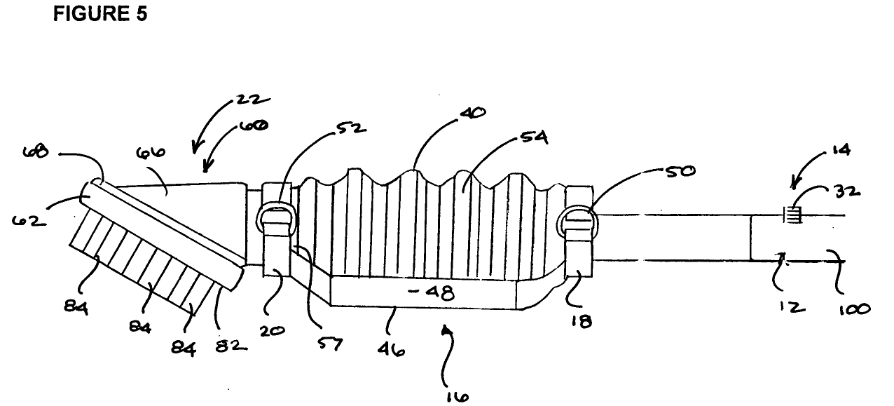

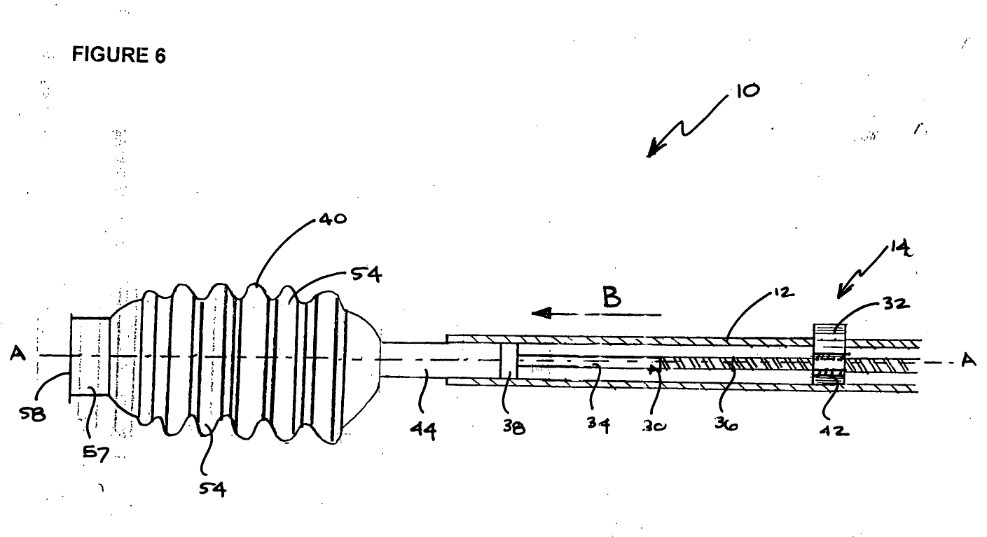

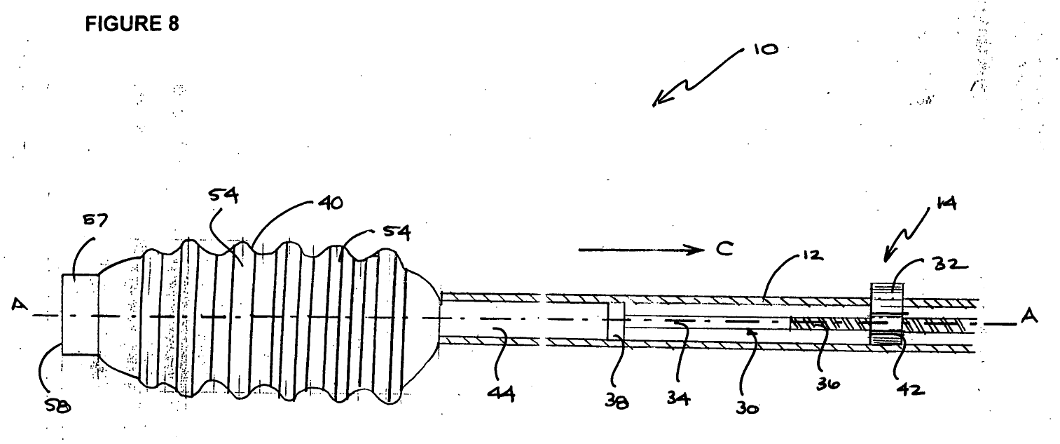

Referring to FIGS. 5, 6, 7 and 8, the sauce dispensing mechanism 14 is adapted to be movably actuated to an engaged position and returnably actuated to a disengaged position within the handle member 12. The sauce dispensing mechanism 14 includes a piston 30 disposed within the handle member 12 and a drive screw 32 rotatably supported on the handle member 12. The piston 30 consists of a rod 34 having a threaded portion 36 at least partially along its length and an end cap 38 for engaging with a sauce cartridge 40 contained within the receptacle member 16. The drive screw 32 includes a threaded interior surface 42 which is adapted to drivingly engage with the threaded portion 36 on the rod 34. In an engaged position shown in FIG. 6, the counterclockwise rotational actuation of the drive screw 32 relative to the longitudinal axis A-A of the handle member 12 advances the rod 34 together with the end cap 38 in the direction B along the bore 26 into an elongated end 44 of the cartridge 40 to dispense sauce from the cartridge 40. In a disengaged position shown in FIG. 8, the clockwise rotational actuation of the drive screw 32 retracts the rod 34 and the end cap 38 in the direction C within the bore 26 away from the elongated end 30 of the cartridge 40 causing the cartridge 40 to elongate and substantially stop the dispensing of sauce from the cartridge 40.

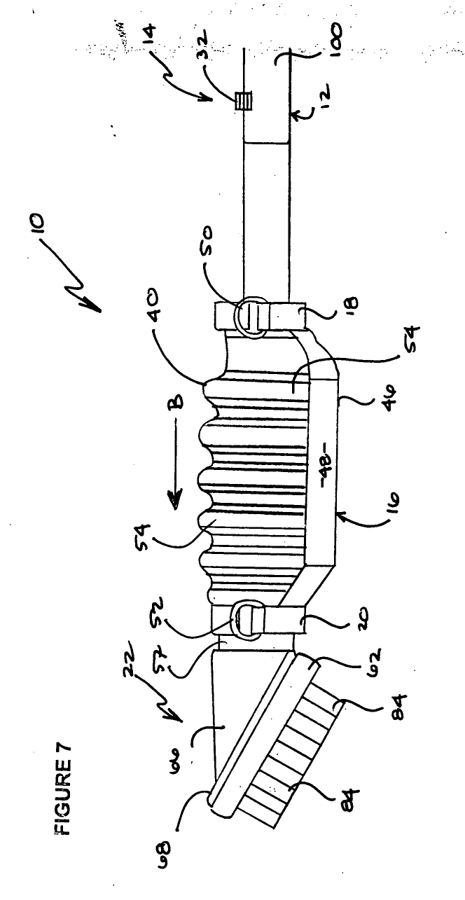

Referring to FIGS. 5 and 7, the receptacle member 16 has a body member 46 for accommodating the cartridge 40 containing the sauce to be dispensed and spread on the food. The body member 46 has a bottom wall 48 which supports the cartridge 40, a first clamp means 50 provided at the proximal end 18 and a second clamp means 52 provided at the distal end 20 for releasably securing the cartridge 40 to the receptacle member 16. The cartridge 40 includes the elongated end 44 positioned adjacent to the proximal end 18 of the receptacle member 16, a pleated bellows 54, and a cartridge extension 57 forming an orifice 58 adjacent to the distal end 20 of the receptacle member 16. The elongated end 44 is dimensioned to be inserted into the bore 26 of the handle member 12 for engaging with the end cap 38 of the sauce spreading mechanism 14. The cartridge 40 is manufactured from a resilient, but generally shape retaining, plastic material. Preferably, the cartridge 40 is manufactured from a medium or low-density polyethylene or polypropylene material or any material having like resiliency. It will be understood that the cartridge 40 may be filled while in place within the receptacle member 16 or may be readily removed and replenished or replaced with another cartridge 40 containing the same or a different sauce.

Referring to FIGS. 6 and 8, when the drive screw 32 of the sauce spreading mechanism 14 is movably actuated in a counterclockwise direction, the end cap 38 engages with the elongated end 30 of the cartridge 40 causing the pleated bellows 54 to compress or collapse to dispense the sauce through the orifice 58 into the base 22. The drive screw 32 may then be returnably actuated in a clockwise direction to cause the end cap 38 of the sauce dispensing mechanism 14 to retract within the handle member 12. The pleated bellows 54 and elongated end 30 are designed to exert a biasing force against the end cap 38 of the sauce dispensing mechanism 14 of such magnitude as to facilitate the returnable actuation of sauce dispensing mechanism 14.

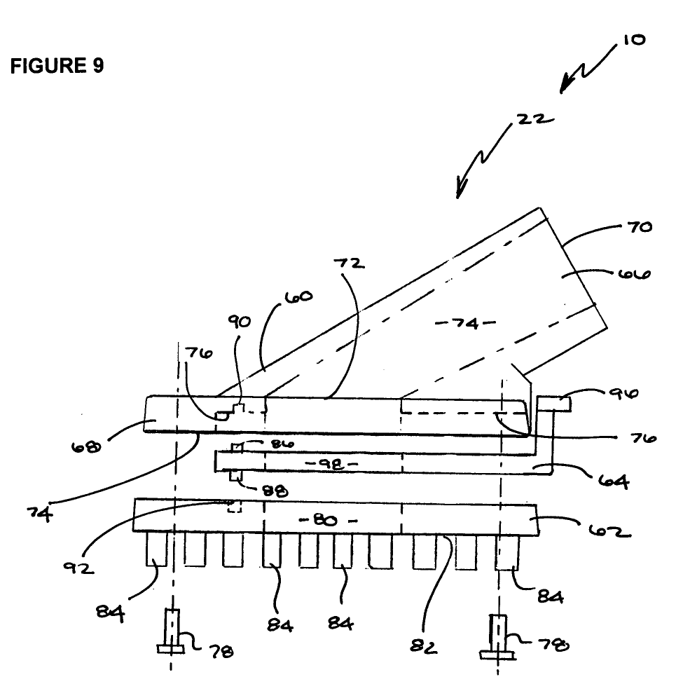

Referring to FIGS. 9, 10, 11, 12 and 13, the base 22 includes a base member 60, a cover member 62 and a pivotal member 64 disposed between the base member 22 and the cover member 62. The base member 60 includes a tapered upper section 66 and a generally rectangular lower section 68. The upper section 66 is provided with an input aperture 70 which is in fluid communication with the orifice 58 on the cartridge 40. The lower section 68 is provided with an output aperture 72 which is in fluid communication with the input aperture 70 via a passageway 74 extending from the input aperture 70 to the output aperture 72. An outer surface 74 of the lower section 68 is formed with a recessed portion 76 which is adapted to receive the pivotal member 64.

The cover member 62 is slidingly received on the lower section 68 of the base member 60 to generally retain the pivotal member 64 within the recessed portion 76 of the lower section 68. The cover member 62 may be releasably secured to the base member 60 using a plurality of fastening means 78 as is known in the art. The cover member 62 is formed with an outer aperture 80 which substantially aligns with the output aperture 72 on the lower section 68 of the base 22 to ensure fluid communication between the base member 60 and the cover member 62. An outer surface 82 of the cover member 62 is provided with a plurality of protrusions 84 extending generally perpendicularly there from for spreading the sauce dispensed through the outer aperture 80 onto the food. The protrusions 84 may have any suitable shape and dimensions as is known in the art for spreading sauce on a food. Preferably, the protrusions 84 are manufactured from a flexible and heat resistant plastic material. The cover member 62 is designed to be independently replaceable in the event that the protrusions 84 become worn or damage following repeated use.

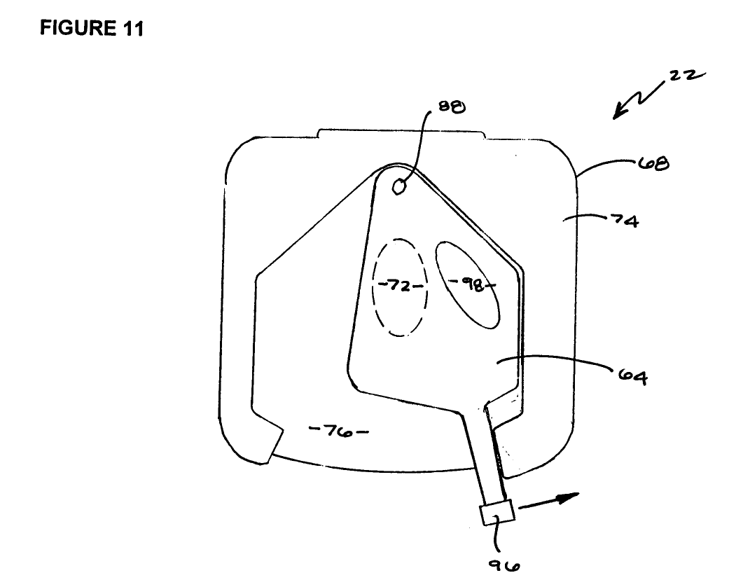

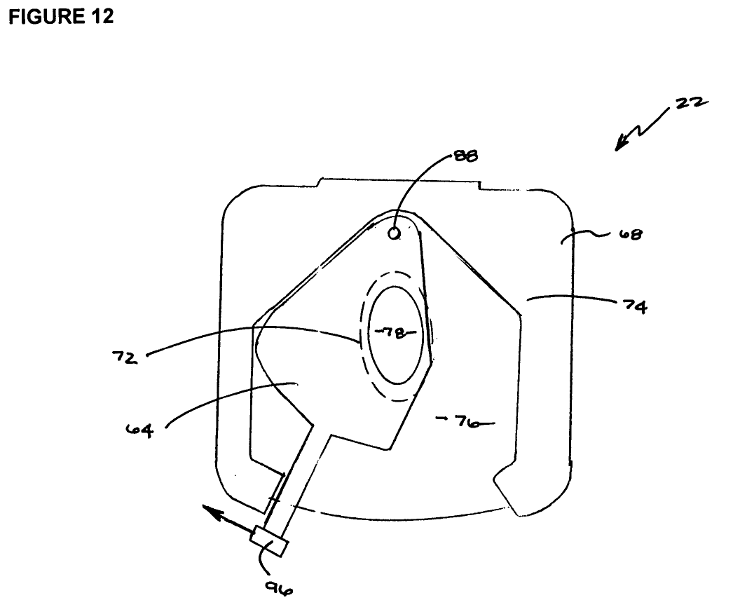

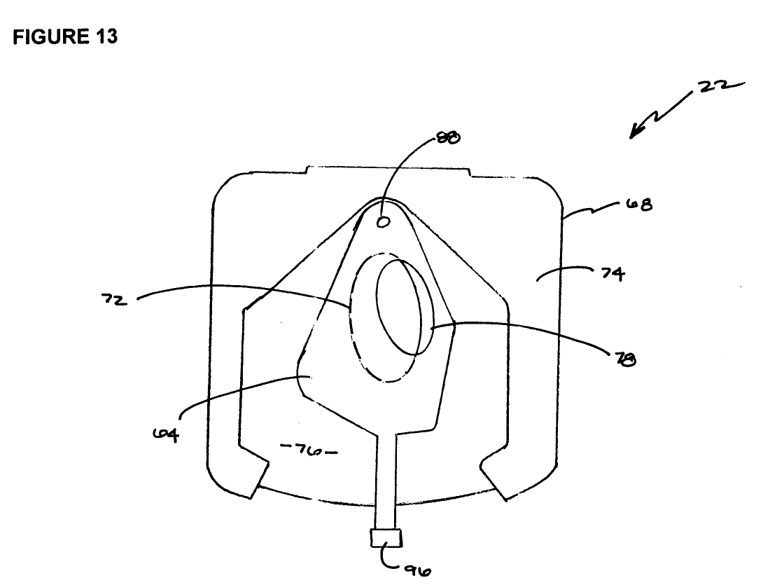

Referring to FIGS. 9, 11, 12 and 13, the pivotal member 64 is adapted for pivotal movement between a closed position and an open position to control the amount of sauce dispensed through the outer aperture 80. The pivotal member 64 includes a first nub 86 and a second nub 88, wherein the first nub 86 is received in a first cooperating pivot point 90 formed in the recessed portion 76 of the lower section 68 of the base member 60, and wherein the second nub 88 is received in a second cooperating pivot point 92 formed in an inner surface 94 of the cover member 62. The pivotal member 64 further includes a lever 96 extending from between the base member 60 and the cover member 62 which is adapted to be engaged by the fingers of the barbeque user to pivotally move the pivotal member 64 between the closed position and the open position. As shown in FIG. 11, in the closed position the pivotal member 64 is positioned over the output aperture 72 to prevent the flow through of the sauce from the cartridge 40. In the open position shown in FIG. 12, a control aperture 98 provided through the pivotal member 64 is substantially aligned with the output aperture 72 on the base member 60 and the outer aperture 80 on the cover member 62 to permit the flow through of the sauce from the cartridge 40 upon the actuation of the sauce dispensing mechanism 14. The pivotal member 64 may alternatively be moved to a partially open position to limit the flow of the sauce or to dispense a measured amount of sauce upon the actuation of the sauce dispensing mechanism 14 (as shown in FIG. 13). It will be apparent that the cook may control the extent of rotation of the drive screw 32 of the sauce dispensing mechanism 14 to obtain short or prolonged dispensing of the sauce.

In a further embodiment of the present invention shown in FIGS. 1, 2, 3 and 4, the handle member 12 may be provided with a heat-resistant sleeve 100 to minimize the transmission of heat from the sauce spreading device 10 to the hand of the barbeque user. The heat-resistant sleeve 100 may be made of any suitable material such as, for example, polypropylene or polyethylene. It should be understood that the handle member 12 and the base 22 may be manufactured from any suitable material known by persons skilled in the art. For example, the handle member 12 and the base 22 may be manufactured from stainless steel, polypropylene or polyethylene.

The present invention has been described with regard to specific embodiments. However, it will obvious to persons skilled in the art that a number of variants and modifications can be made without departing from the scope and spirit of the invention, the scope of which is defined in the appended claims.

1. A sauce spreading device for dispensing and spreading a sauce on food, the sauce spreading device comprising:
a hollow handle member;
a sauce dispensing mechanism substantially positioned within the handle member, the sauce dispensing mechanism being movably actuated between an engaged position and returnably actuated to a disengaged position;
a receptacle member having a proximal end and a distal end, the handle member being coupled to the proximal end of the receptacle member, the receptacle member having a body member for accommodating a cartridge containing the sauce; and
a base coupled to the distal end of the receptacle member, wherein the base having an input aperture, an output aperture and a passageway in fluid communication with the cartridge and extending from the input aperture to the output aperture;
wherein the movable actuation of the sauce dispensing member causing a the cartridge to be collapsed so that the sauce is dispensed from the cartridge through the base; and
wherein the returnable actuation of the sauce dispensing member causing the collapsed cartridge to be elongated so that the dispensing of the sauce from the cartridge through the base is substantially stopped.

2. A sauce spreading device as claimed in claim 1, the sauce dispensing mechanism further comprising a piston and a drive screw rotatably supported on the handle member, wherein the rotation of the drive screw relative to the handle member provides axial movement of the piston within the handle member.

3. A sauce spreading device as claimed in claim 2, the piston further comprising a rod having a threaded portion at least partially along its length and an end cap for engaging with an end of the cartridge.

4. A sauce spreading device as claimed in claim 2, the base further comprising a base member and an outer cover member releasably coupled to the base member, the base member formed with the output aperture therethrough, and the outer cover member formed with an outer aperture in fluid communication with the output aperture.

5. A sauce spreading device as claimed in claim 4, further comprising a pivotal member disposed between the base member and the outer cover member and adapted for pivotally moving between a closed position and an open position to control the amount of sauce dispensed through the outer aperture.

6. A sauce spreading device as claimed in claim 5, wherein the base member is provided with a recessed portion which is adapted to receive and enable the pivotal movement of the pivotal member between the closed position and the open position.

7. A sauce spreading device as claimed in claim 5, wherein the pivotal member pivots about a first cooperating pivot point on the base member and a second cooperating pivot point on the outer cover member.

8. A sauce spreading device as claimed in claim 5, wherein the pivotal member has a lever engageable by fingers for pivotally moving the pivotal member between the closed position and the open position.

9. A sauce spreading device as claimed in claim 4, further comprising a plurality of protrusions extending generally perpendicularly from a surface of the outer cover member for spreading the sauce dispensed through the outer aperture.

10. A sauce spreading device as claimed in claim 4, wherein the outer cover member is independently replaceable.

11. A sauce spreading device as claimed in claim 9, wherein the plurality of protrusions are manufactured from a flexible plastic material.

12. A sauce spreading device as claimed in claim 1, wherein the cartridge having a pleated bellows formed with an orifice at one end and adapted to contain the sauce to be dispensed through the orifice upon the collapse of the pleated bellows.

13. A sauce spreading device as claimed in claim 9, wherein the cartridge is formed of a resilient material for normally biasing the bellows to an elongated condition.

14. A sauce spreading device as claimed in claim 1, wherein the body member is provided with a first clamp and a second clamp for releasably securing the cartridge to the body member.

15. A sauce spreading device as claimed in claim 1, wherein the handle member is provided with a heat-resistant sleeve.

16. A sauce spreading device as claimed in claim 1, wherein the first end of the handle member is provided with a hook means.

17. A sauce spreading device for dispensing and spreading a sauce on food, the sauce spreading device comprising:
a hollow handle member;
a receptacle member having a proximal end and a distal end, the handle member being coupled to the proximal end of the receptacle member, the receptacle member accommodating a cartridge containing the sauce and having a pleated bellows and an orifice at one end;
a sauce dispensing mechanism substantially positioned within the handle member to engage and collapse the pleated bellows to dispense the sauce through the orifice.

18. A sauce spreading device as claimed in claim 17, further comprising a base coupled to the receptacle member, wherein the base having an input aperture, an output aperture and a passageway in fluid communication with the orifice and extending from the input aperture to the output aperture.

19. A sauce spreading device as claimed in claim 18, further comprising a plurality of protrusions extending generally perpendicularly from an outer cover member of the base adapted for spreading the dispensed sauce.

20. A sauce spreading device as claimed in claim 19, the sauce dispensing mechanism further comprising a piston and a drive screw rotatably supported on the handle member, wherein the rotation of the drive screw relative to the handle member provides axial movement of the piston within the handle member to collapse the pleated bellows.
